(19) United States
(12) Patent Application Publication
(10) Pub. No.: US 2014/0123028 A1
(43) Pub. Date: May 1, 2014

(54) COMPREHENSIVE MULTIMEDIA MANAGEMENT PLATFORM

(71) Applicant: Kiran Kamity, Santa Clara, CA (US)

(72) Inventor: Kiran Kamity, Santa Clara, CA (US)

(21) Appl. No.: 13/662,432

(22) Filed: Oct. 27, 2012

(51) Int. Cl. G06F 3/01; G06F 15/16

(52) U.S. Cl. 715/753

(57) ABSTRACT

The embodiments herein relate to multimedia content management and, more particularly, to management of multimedia content in any data communication network such as an enterprise network. Any authorized user may create content using a content creation option provided with the system. The content creation modes may be audio, video, images and so on. Further, the created content is hosted on a server associated with the enterprise network. Further, the user can share the content hosted on the server using various mediums such as email, instant messages, social networking websites and so on. A user can request for specific content stored in the server. Upon receiving the content access request from the user, the system checks whether the user is authenticated to access the requested content or not. Upon verifying authenticity of the user, the system streams the requested content to the user using an associated streaming platform.

The present application is based on, and claims priority from U.S. Provisional Application No. 61/433,254, filed on 16 Jan., 2011 and is a Continuation In Part of the US Complete Application Number 2012/0185922, published on 19 Jul. 2012, the disclosure of which is hereby incorporated by reference herein.

### TECHNICAL FIELD

The embodiments herein relate to multimedia content management and, more particularly, to management of multimedia content in a data communication network.

### BACKGROUND

Use of multimedia (video, audio and so on) for communication and entertainment has seen an explosive growth in recent times. The reasons for such rapid growth in use of multimedia can be attributed to easy and cheap availability of storage, general increase in bandwidth available to users, workforces being spread over various geographic areas, and availability of content creation means (such as cameras, microphones, touchscreen devices and so on) among many other factors.

Enterprises are also trying to use more and more multimedia for the purposes of customer support, communication and education. However, in a typical enterprise today, there is no coordination among users in the way they manage multimedia content within the enterprise. The problem is compounded when there are multiple groups within an organization. One group may use a public cloud based service like YOUTUBE. Another group may be using a local server within the enterprise network to store and retrieve their content. And other groups may just be emailing these files as large attachments! The problem with using a consumer oriented cloud based service is that they do not usually suit the management and security requirements of an enterprise. While services like YOUTUBE do have a facility to share content privately, they require users to register on their platform to avail such services. And, it may not be practical for everyone in a group or even an enterprise to register for a particular service as individuals instead of being integrated with the corporate user database.

Various public consumer oriented cloud based services like YOUTUBE have become popular and are useful to manage multimedia content for individuals within an enterprise. However, such services fall short of catering to the needs of enterprises to control and manage multimedia content in a secure manner within the enterprise.

Integrating a multimedia management solution within an existing enterprise network such as illustrated in FIG. 1 can be a daunting task as such integration may involve adding one or more servers for hosting and streaming video, adding one or more storage appliances, or configuring and using one or more existing storage appliances for video storing/backup, deploying custom application software on one of the servers that can perform tracking of video usage within the enterprise to perform analytics, and security functions like authentication and authorization.

Further from the client perspective, content creation and management has a significant role in applications such as online tutorials, lectures, customer support, online advertisements and so on. With internet based services having clear edge over other communication and data exchange means in today's world, the online advertisements and other distributed contents reaches maximum number of people round the globe.

The online advertisement and content distribution comprises two main steps namely content creation and distribution. The content may be audio, video or a combination of both. A user can create the content using suitable means such as audio/video capturing devices, touch screen devices, editing software and so on. Further, the content is uploaded to suitable websites such as content sharing websites or else is mailed to email Ids of people to whom the content is to be delivered.

One disadvantage of the existing systems is that the user may require separate systems or means for creating content and to securely share or distribute the created content. As a result of this, the time and effort required for the user to create and upload/share content is more. Further, when content is uploaded or shared, people who receive or view the content may be having own views and opinions about the content. Such feedback from viewers may help the user in improving or modifying the content. In existing systems, the user may have to order to receive such feedback by logging in separately to different web based video portals and social networking web sites to which the content/advertisement has been uploaded. This again demands more user effort and also consumes more time.

In view of the foregoing, an embodiment herein provides a method for managing content in an enterprise network, the method comprises presenting one or more options to choose a content creation mode; creating the content based on selected option to create content from among the options to create content, wherein the content is one or a combination of one or more among audio, camera video, whiteboard video, screen share video, application share video and screen capture image; creating metadata for the created content; transferring the content to a server for hosting; presenting options to share the hosted content and sharing the content based on selected option to share from among the options to share.

Embodiments further disclose a system for managing content in an enterprise network, the system provided with at least one means configured for presenting one or more options to choose a content creation mode using a user device; creating the content based on selected option to create content from among the options to create content, wherein the content is one or a combination of one or more among audio, camera video, whiteboard video, screen share video, application share video and screen capture image using a unified multimedia appliance; creating metadata for the created content using the unified multimedia appliance; transferring the content to a server for hosting using the unified multimedia appliance; presenting options to share the hosted content using the user device and sharing the content based on selected option to share from among the options to share using the unified multimedia appliance.

These and other aspects of the embodiments herein will be better appreciated and understood when considered in conjunction with the following description and the accompanying drawings.

### BRIEF DESCRIPTION OF THE FIGURES

The embodiments herein will be better understood from the following detailed description with reference to the drawings, in which:

FIG. 1 illustrates an enterprise network;

FIG. 2 depicts a unified multimedia appliance in an enterprise cloud connected to a plurality of users spread across multiple locations, according to embodiments as disclosed herein;

FIG. 3 depicts a unified multimedia appliance in an enterprise cloud providing a plurality of views, according to embodiments as disclosed herein;

FIG. 4 depicts a unified multimedia appliance, according to embodiments as disclosed herein;

FIG. 5 depicts a process of processing and storing of content in an organization, according to embodiments as disclosed herein;

FIG. 6 depicts a user requesting for content, according to embodiments as disclosed herein;

FIG. 7 depicts a user requesting for content, according to embodiments as disclosed herein;

FIG. 8 is a flow diagram that shows various steps involved in the process of users creating and sharing contents in the enterprise network, as disclosed in the embodiments herein;

FIG. 9 is a flow diagram that shows various steps involved in the process of creating content in the enterprise network, as disclosed in the embodiments herein;

FIG. 10 is a flow diagram that shows various steps involved in the process of sharing created contents through websites in the enterprise network, as disclosed in the embodiments herein; and

FIGS. 11-23 depict screenshots of various user interfaces provided to the user for creating contents and sharing created contents in the enterprise network, as disclosed in the embodiments herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

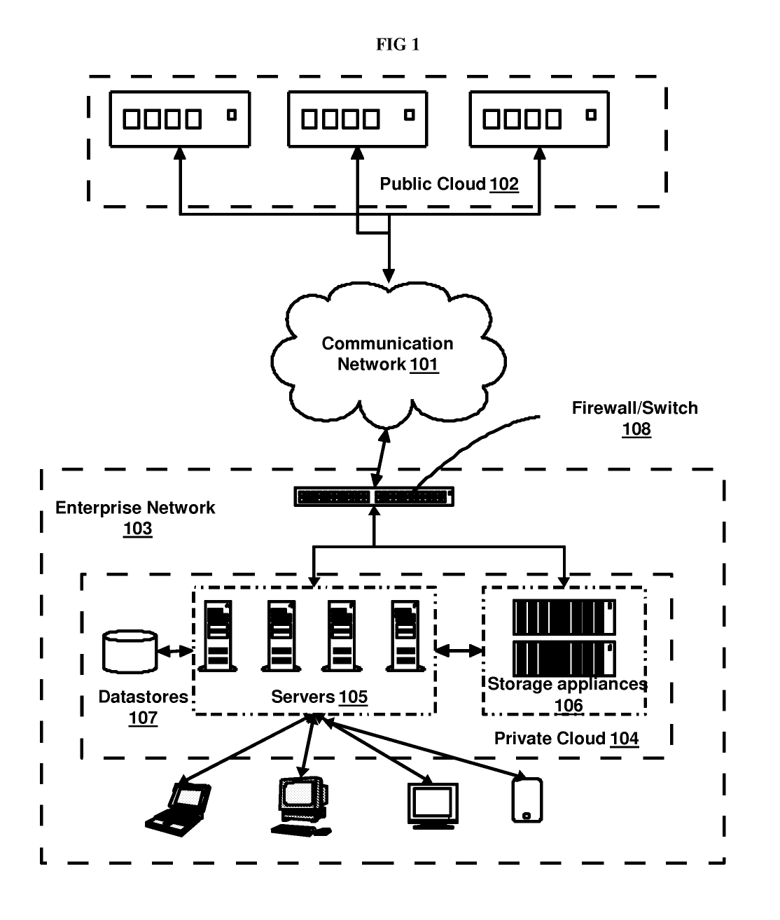

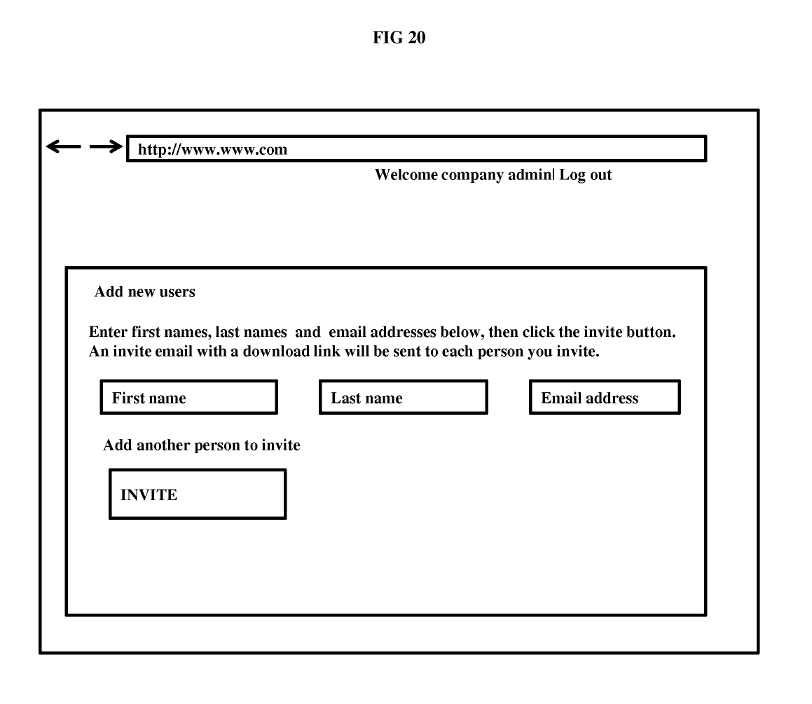

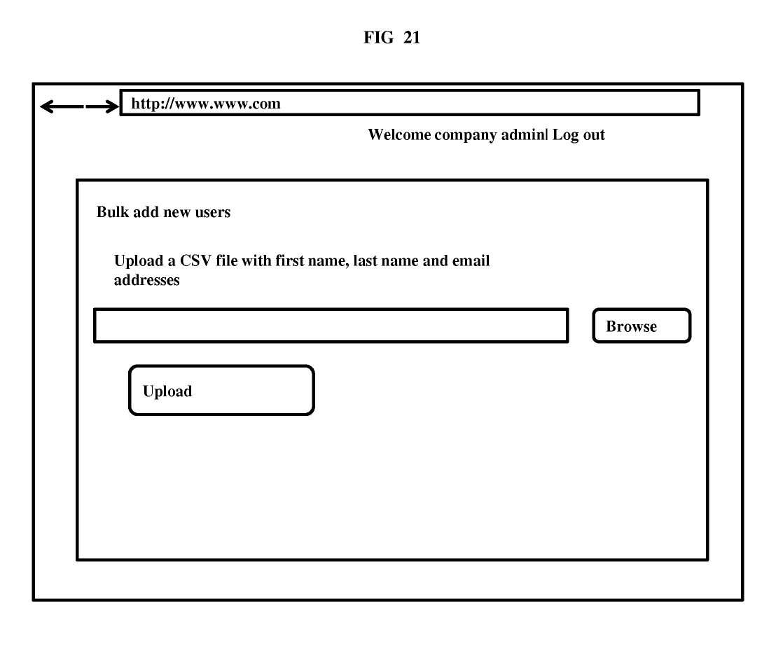

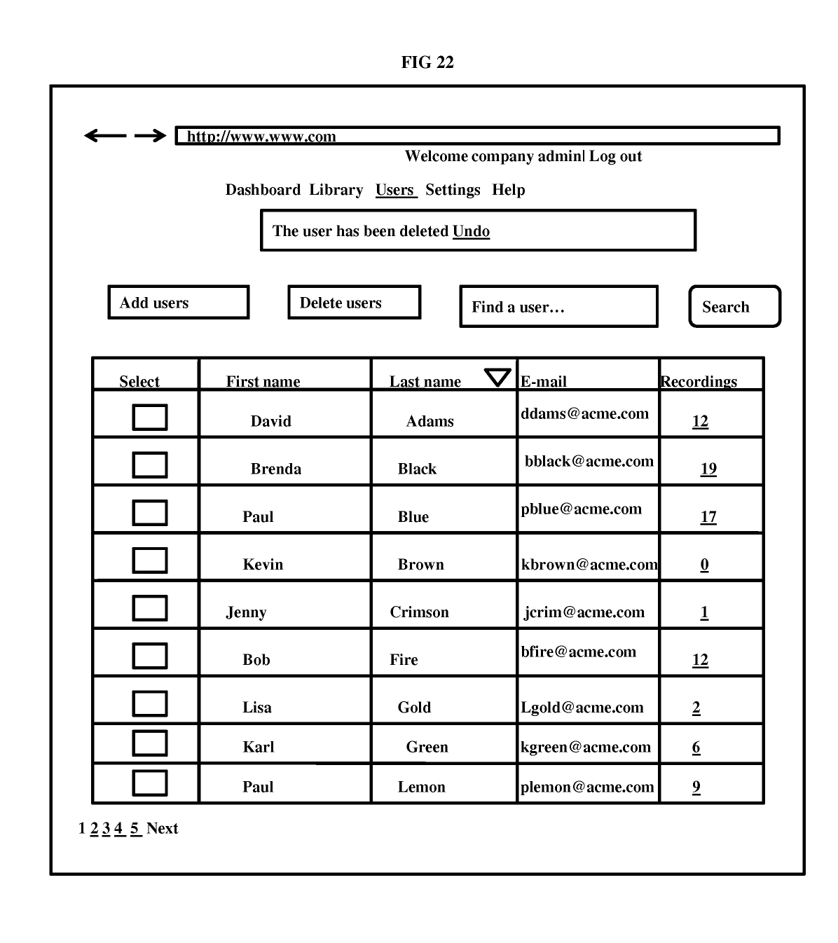

The embodiments herein disclose a unified method of managing multimedia content in an organization using a system that is responsible for efficient storage, archival, analytics, authentication, creation, editing, sharing, broadcast, and encoding of the content. Referring now to the drawings, and more particularly to FIGS. 1 through 23, where similar reference characters denote corresponding features consistently throughout the figures, there are shown embodiments.

FIG. 1 broadly illustrates a communication network 101 connecting a public cloud 102 and an enterprise network 103. Enterprise network 103 can be a complex network with multitude of network elements used for various purposes. In fact, some enterprise networks can be much more complex than as depicted in FIG. 1 as there could multiple locations of offices that are geographically distributed.

With the ever increasing use of multimedia content (example video) as a mode of communication medium, there is an increasing need to access and store videos to enable day to day functions within an enterprise. Today, in a typical enterprise, there is no coordination among users in the way they manage multimedia content within the enterprise. The problem is compounded when there are multiple groups within an organization. One group may use a public cloud based service like YOUTUBE. Another group may be using a local server within the enterprise network to store and retrieve their content. The disparate used for managing multimedia content. The problem with using a consumer oriented service is that they do not usually suit the management and security requirements of an enterprise. While services like YOUTUBE do have a facility to share content privately, they require users to register on their platform to avail such services. And, it may not be practical for everyone in a group or even an enterprise to register for a particular service.

Integrating a multimedia management solution within an existing enterprise network such as illustrated in FIG. 1 can be a daunting task as such integration may involve adding one or more servers for hosting and streaming video, adding one or more storage appliances, or configuring and using one or more existing storage appliances for video storing/backup, deploying custom application software on one of the servers that can perform tracking of video usage within the enterprise to perform analytics, and security functions like authentication and authorization.

Therefore, there is a need for a simpler and easier to configure solution that provides integration and security along with the convenience of public cloud based services.

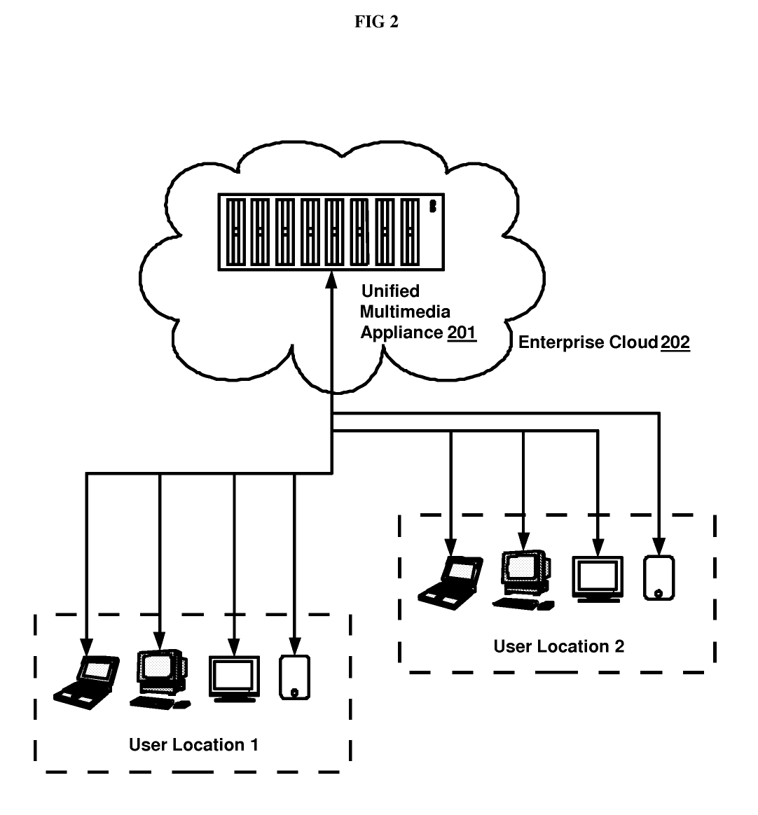

FIG. 2 depicts a unified multimedia appliance in an enterprise datacenter or cloud connected to a plurality of users spread across multiple locations, according to embodiments as disclosed herein. The unified multimedia appliance 201 is present within an enterprise cloud 202, and can provide a single interface for all users across multiple locations within an enterprise. The users may access the cloud using any device capable of connecting to the cloud 202, such as a laptop, desktop, personal computer, tablet, PDA, mobile phone and so on. The users may further comprise of administrators, management and so on. The users may create and edit multimedia content using a browser, standalone application or a widget embedded into other enterprise applications. The multimedia content may comprise of a combination of at least one of audio, video whiteboard and screen content (text, graphical content, a combination of text and graphics and so on).

The user may create and/or edit the content using an application that works from the device used by the user, where the device may accept inputs in the form of a combination of at least one of text, audio, video, touch screen and so on. The application may comprise but not be limited to a client that works from the browser, a standalone application (wherein the standalone application may be a computer application (which may be running on a computer, tablet, PDA and so on) or an app for a portable device (such as an app for the iPhone, android based devices and so on)), a widget embedded into other applications/tools (where the application/tool may be a browser (Internet Explorer, Firefox, Google Chrome, Safari and so on), an email management application (Outlook, Outlook Express, Thunderbird and so on), an office suite (Microsoft Office, Lotus Notes, OpenOffice.org and so on), a browser based email provider (Gmail, Hotmail, Yahoo and so on), a communication tool (Skype, Microsoft Communicator, Gtalk, Yahoo Messenger and so on), a social networking means (FaceBook, Google+, Linkedin and so on), a customer support tool (SalesForce, NetSuite and so on), an employee management tool (such as a time sheet tracker, an appraisal tool and so on)). The user may also use a dedicated device such as a multimedia recorder (such as a voice recorder, a video recorder, a transcriber, a scanner and so on). The user may also fetch the content from a remote location using the device. This content may be uploaded onto the appliance 201 using suitable client means, either using streaming or uploading.

The unified multimedia appliance 201 provides a single appliance solution for managing multimedia needs of an enterprise. The appliance 201 provides the convenience of a public cloud based service, but with management and enhanced security and control over the media content being used and distributed within the enterprise. In various embodiments, the appliance 201 may provide the following facilities:

Automatic Video Merging to a Unified Format: The unified multimedia appliance 201 may merge multiple types of content based on user input and/or transcode/convert the content into a pre-specified format. For example, user may provide multiple files or sources as input. The appliance 201 fetches all the input files and merges them to a single file to a pre-specified format. Examples of various file formats that can be combined include, but are not limited to, video files such as WINDOWS MEDIA VIDEO, and REAL MEDIA VIDEO; slide show files PPS, PPT, and ODP; Image formats such as JPEG, BMP, GIF; audio files such as WMA, AMR, and so on.

Hosting/Streaming in a Unified Format: In a preferred embodiment, the format to which content is converted to may be uniform (such as H264) for all content associated with the multimedia appliance 201 across the enterprise. In various other embodiments, the format to which a file is converted to may vary based on user requirements, including but not limited to nature of content, the purpose of the content, associated tags, the department from which the file is uploaded, and so on. For example, if a video uploaded is to be used for training purposes, such a video may be given higher preference and therefore may be stored in a format that provides higher quality as compared to a video that is for the purposes of fun and entertainment.

The unified multimedia appliance 201 enables users to access content by streaming the content to the users, after authenticating and authorizing the users. The unified multimedia appliance 201 may fetch requested content from an internal storage means. The unified multimedia appliance 201 may also fetch requested content from an external storage means.

Content Tagging: The unified multimedia appliance 201 may also tag the content. The tags may depend on the content, the user who uploaded the content, the date and time the content was created and uploaded, additional information associated to the video by the user, explicit tags information provided by the user, and so on.

Storage and Backup: The unified multimedia appliance 201 can act as a storage appliance and provide storage and backup facilities like an off-the-shelf storage appliance. In this case, all the multimedia as well as metadata information (title/description/tags/analytics etc.) is stored in the appliance. This data can be stored either as flat files or inside a database. This data can also be replicated/backed up on a periodic basis for failover and redundancy. In various embodiments, the appliance 201 can be built to work with an existing storage appliance, such as the appliances provided by HP, NETAPP, EMC2 and so on. In this case, the appliance (201) will redirect all storage to a different storage appliance (NAS/SAN/Windows File Servers etc.), most likely one that is already being used by the enterprise. In this case, redundancy/failover (replication or backup) are handled by this 3^{rd} party appliance/software. This is especially true if the appliance (201) is a software install or a virtual machine. Storage can also be handled by cloud storage providers such as Amazon S3.

In various embodiments, the appliance may store information locally based on appliance configuration. In some embodiments, the appliance may be configured to connect to an external storage appliance or a storage device.

Further, in some embodiments, automatic backups of content to an internal storage means may be enabled. In some other embodiments, the unified multimedia appliance 201 may also take backups of content to an external storage and/or backup means.

Analytics: The unified multimedia appliance 201 may also collect and store analytics related to the accessing of content, such as the number of times a specific content has been accessed, the dates and times of access, the list of users accessing a specific content, the location of users accessing information within the enterprise, and so on.

Authentication and Authorization using existing enterprise user authentication infrastructure: In present systems, IT administrators use a plurality of means for managing media at the same time, and one of the critical issues with such an ad-hoc approach is the difficulty to control and manage content at a single place. In a preferred embodiment, the appliance 201 automatically connects to standards based authentication means within an enterprise to provide authentication and authorization for media content upload and access across the enterprise without any additional setup. The appliance 201 can connect to existing authentication systems like LDAP, Microsoft's Active Directory, Novell's Netware/Directory Services and so on. With such integration, users within an enterprise need not provide special credentials to access content. Also, authorization can be managed using these existing groups (such as Active Directory groups) The appliance automatically fetches information about the user from existing systems and therefore, provides greater convenience and efficiency in managing and controlling the multimedia activity within the enterprise.

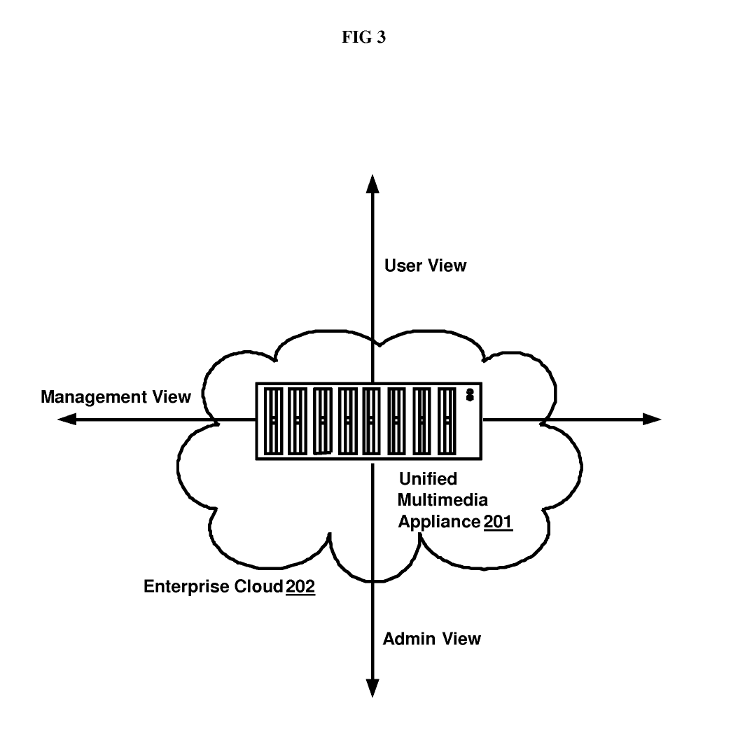

FIG. 3 depicts a unified multimedia appliance in an enterprise cloud providing a plurality of views, according to embodiments as disclosed herein. The unified multimedia appliance 201 provides distinct interfaces for users, administrators and management to access the unified multimedia appliance 201. The user interface may comprise of a means for a user to create/edit/access/view the content. The user interface may be a web application based interface, a standalone interface or a widget embedded into other applications or websites. The administrator view provides an interface for an administrator to control the unified multimedia appliance 201. The administrator may control factors such as the type of format in which content is to be stored, the tags associated with the content, the location where the content is to be stored, the location to where the content is to be backed up and so on. The administrator may also access the analytics collected by the unified multimedia appliance 201 and perform further operations on the same. The Management view enables people from the management to view analytics collected by the unified multimedia appliance 201 and perform further operations on the same. The IT view enables the appliance 201 to interact with existing network infrastructure, such as storage, backup and authentication means exiting in the network.

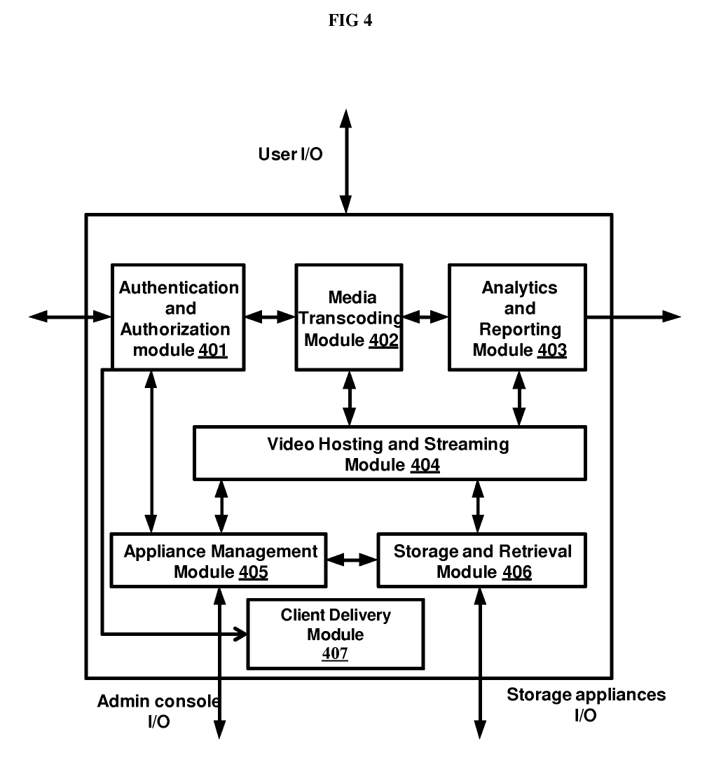

FIG. 4 depicts a unified multimedia appliance, according to embodiments as disclosed herein. The unified multimedia appliance 201 comprises of an authentication and authorization module 401, a media transcoding module 402, an analytics and reporting module 403, a video hosting and streaming module 404, an appliance management module 405, a storage and retrieval module 406 and a client delivery module 407. The unified multimedia appliance 201 also comprises of a plurality of interfaces such as a user interface, an authorization interface, an admin console interface, a storage appliances interface and a reports and notification interface.

On a user requesting for content from the unified multimedia appliance 201, the authentication and authorization module 401 verifies if the user is authorized to access the appliance 201. The authentication and authorization module 401 may access an external module for the verification. The authentication and authorization module 401 may verify if the user logging in qualifies for the role of an administrator and/or management before permitting access to the appliance 201. The authentication and authorization module 401 may also be responsible for deciding the level access of the user/administrator/management depending on the roles and capabilities of the person accessing the appliance 201.

The media transcoding module 402 transcodes content from one format to the standard format. The media transcoding module 402 may also merge content from various sources and platforms and/or transcode content into a uniform format. This is usually done to enable better streaming over high latency or low bandwidth connections. In an embodiment herein, the uniform format may be H.264 format. The media transcoding module 402 may transcode the content, when the content is being received by the appliance 201. The media transcoding module 402 may also transcode the content on receiving an instruction from the administrator or the user. The media transcoding module 402 may transcode the content format with the objective of being able to consume least storage footprint while providing a format that is viewable on multiple end user devices using a standard means. The media transcoding module 402 may also tag the content depending on the content, the user who uploaded the content, the date and time the content was created and uploaded and so on. It may also extract the audio from the content and convert it to text for better search/tagging/indexing,

The analytics and reporting module 403 enables the appliance 201 to collect analytics regarding the content. The analytics may comprise of content such as the number of times a specific content has been accessed, the dates and times of access, the list of users accessing a specific content and so on. The analytics and reporting module 403 may also create reports based on the analytics, on receiving appropriate instructions from the management or the administrator.

The video hosting and streaming module 404 handles streaming of the content to the user using a suitable means. The video hosting and streaming module 404 may also enable creation of content. The video hosting and streaming module 404 fetches the content via the storage and retrieval module 406. The storage and retrieval module 406 may fetch the content from an internal storage means or an external storage means. The storage and retrieval module 406 may be compatible with storage technologies such as RAID (Redundant Array Of Independent Disks). The video hosting and streaming module 404 may stream the content to the user using a standalone application or a browser based application. Depending on the connection or configuration settings, this module might perform streaming or progressive download.

The appliance management module 405 manages the appliance 201. The appliance management module 405 controls the streaming of content to the user. The appliance management module 405 also controls the creation of content, transformation of the content, storage of the content and so on. The appliance management module 405 stores the content in the appropriate location (may be an internal location or an external location). The appliance management module 405 also takes backup of the content to the appropriate location (may be an internal location or an external location).

Further, the client delivery module 407 may help the user to download and install the client application to the user device, based on the operating system the user device is working on. For example, if the user device works on windows operating system the client delivery module 407 helps the user to download the client application that may be optimized to work on the windows operating system. Similarly if the user device works on Mac operating system, the client delivery module 407 helps the user to download a client application that is optimized to work on Mac operating system.

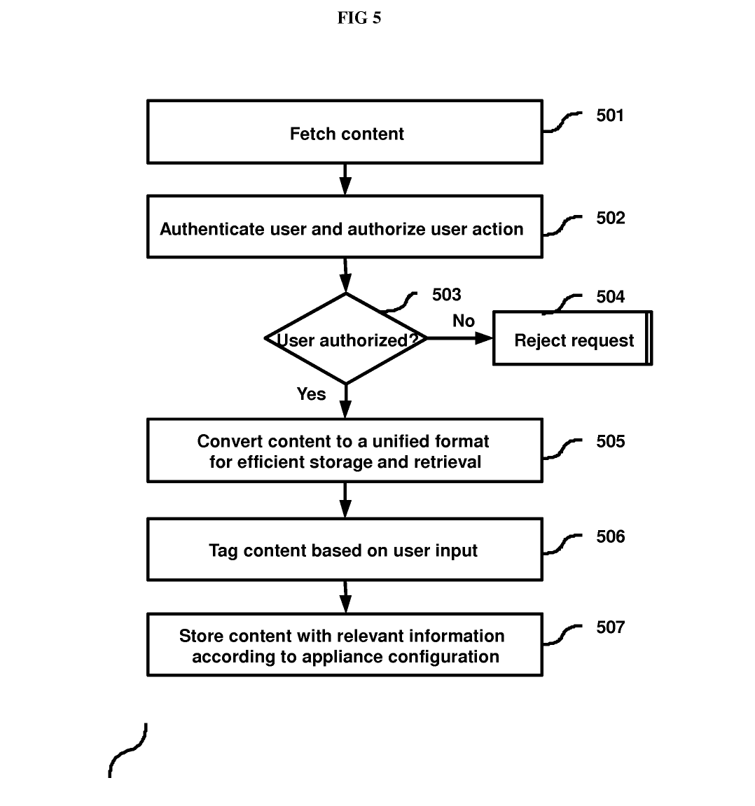

FIG. 5 depicts a process of processing and storing of content in an organization, according to embodiments as disclosed herein. The unified multimedia appliance 201 fetches (501) the content. The content may be fetched from another location accessible to the unified multimedia appliance 201. The content may also be created by a user/administrator/management using an interface made available by the unified multimedia appliance 201. The unified multimedia appliance 201 authenticates (502) the user action. The unified multimedia appliance 201 may leverage internal database or other enterprise authentication mechanisms (such as LDAP, Active Directory etc.) for authentication. The unified multimedia appliance 201 may also use an internal authentication means for authentication. If the user is not authorized (503), the unified multimedia appliance 201 denies (504) permission to the user to access the unified multimedia appliance 201. If the user is authorized (503), the unified multimedia appliance 201 converts (505) the content into a unified format. The content may be merged with other content. In an embodiment herein, the unified format may be H.264. The unified multimedia appliance 201 further tags (506) the content in an appropriate manner. The tags may depend on the content, the user who uploaded the content, the date and time the content was created and uploaded and so on. The unified multimedia appliance 201 further stores (507) the content with related information in a suitable location (may be internal to the unified multimedia appliance 201 or external to the unified multimedia appliance 201). The various actions in method 500 may be performed in the order presented, in a different order or simultaneously. Further, in some embodiments, some actions listed in FIG. 5 may be omitted.

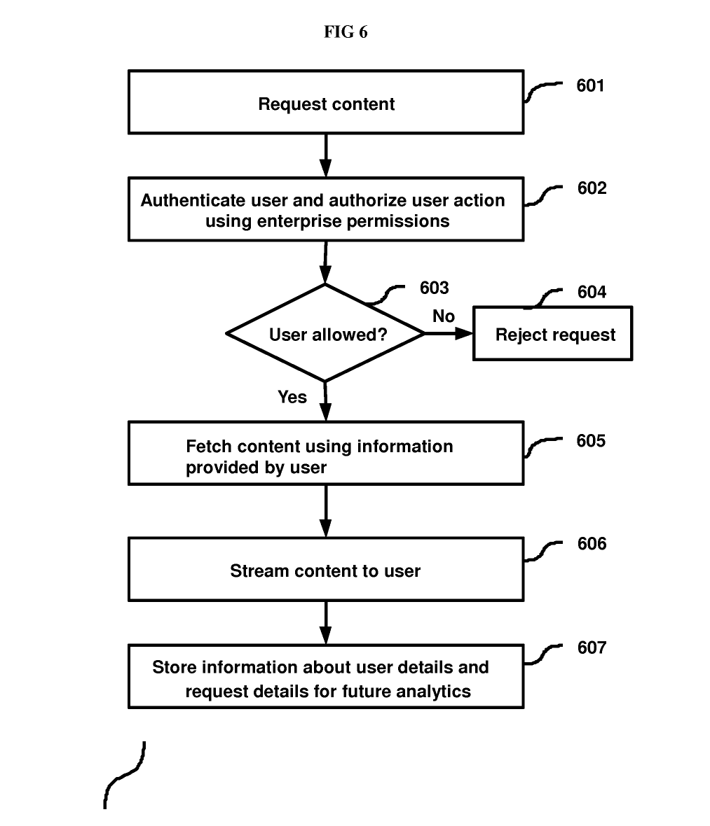

FIG. 6 depicts a user requesting for content, according to embodiments as disclosed herein. On a user requesting (601) content, the unified multimedia appliance 201 authenticates (602) the user action. The unified multimedia appliance 201 may use an external authentication means for authentication. The unified multimedia appliance 201 may also use an internal authentication means for authentication. If the user is not authorized (603), the unified multimedia appliance 201 denies (604) permission to the user to access the unified multimedia appliance 201. If the user is authorized (603), the unified multimedia appliance 201 fetches (605) the content as requested by the user. The unified multimedia appliance 201 authenticates (502) the user action. The unified multimedia appliance 201 may use an external authentication means for authentication. The unified multimedia appliance 201 may also use an internal authentication means for authentication. If the user is not authorized (503), the unified multimedia appliance 201 denies (504) permission to the user to access the unified multimedia appliance 201. If the user is authorized (503), the unified multimedia appliance 201 fetches (605) the content and streams (606) the content to the user using a suitable means. The unified multimedia appliance 201 may fetch the content from an internal storage means or an external storage means. The unified multimedia appliance 201 further stores (607) information about the user and the request. The various actions in method 600 may be performed in the order presented, in a different order or simultaneously. Further, in some embodiments, some actions listed in FIG. 6 may be omitted.

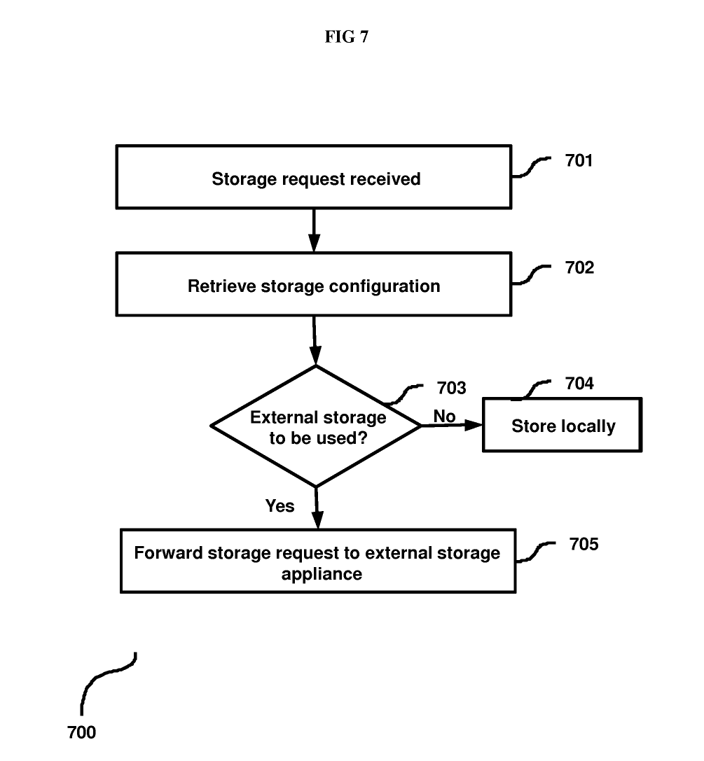

FIG. 7 depicts a user requesting for content, according to embodiments as disclosed herein. On the unified multimedia appliance 201 receiving (701) a request for storage, the unified multimedia appliance 201 retrieves (702) the storage configuration. The storage configuration may be as set by the administrator and may vary depending on the type of content, source of the content, time of upload and so on. On retrieving the storage configuration, the unified multimedia appliance 201 checks (703) if external storage is to be used. If external storage is to be used, the unified multimedia appliance 201 forwards (705) the storage request to the corresponding external storage appliance. If external storage is not to be used, the unified multimedia appliance 201 stores (704) the content locally. The various actions in method 700 may be performed in the order presented, in a different order or simultaneously. Further, in some embodiments, some actions listed in FIG. 7 may be omitted.

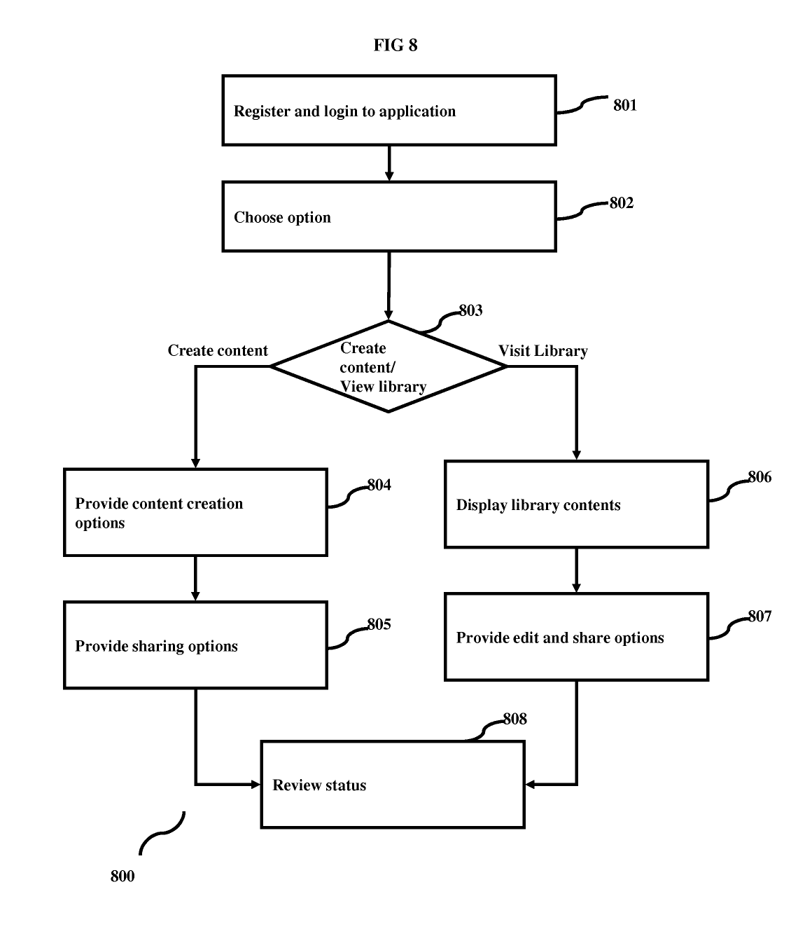

FIG. 8 is a flow diagram that shows various steps involved in the process of users creating and sharing contents in the enterprise network, as disclosed in the embodiments herein. In order to create and share content using the enterprise network, the user has to register to the enterprise network services first. In various embodiments, the user may be able to access the enterprise network services through an application (Enterprise application/client application) that is downloaded and installed in a user device or through a web based portal. The user device in which the user can download and install the enterprise application/client application may be any device such as a mobile phone, a computer, a tablet pc and so on that has internet connectivity. In an embodiment, the enterprise application may be a dedicated application. In another embodiment, functionalities of the enterprise application may be associated with any other application such as Outlook, MS office, chat applications, web browsers and so on installed in the user device. The enterprise network application may be added as a plugin in any of the mentioned applications or else may be in the form of a dedicated widget application. The web based enterprise portal may be accessed by the user through a web-browser installed in the user device.

The user may register to the service by using a sign up option during which the user may be asked to provide certain details such as name, email id, password info and so on. In an embodiment, the user may be able to change or edit the registration and login information later using specific options. Further, the user can login to the service using login information registered during the sign up process. Upon signing in to the enterprise network, the user is provided with (803) various option such as create content, download the client to create and share content, view library and so on. If the user selects option to create content, the user is presented (804) options to select content creation modes and to initiate content creation process. In an embodiment, the content creation mode may be audio, video, white board, images and so on. The user may select any one of or a suitable combination of the modes to create the content.

Once the content has been created, the user may be provided with options to preview the created content. For example, if the user captures a video using a camera associated with the user device and record the video using a screen recording option, the user may be provided with options to preview the captured video, upon completion of the video recording and screen recording. In another example, the user can create image data using a suitable image capturing method such as screen capture. The user can view the captured images using the preview option. Further, the created contents are uploaded to and are saved in a memory module associated with the user account in the enterprise network server 105. In various embodiments, the memory module or the enterprise network as a whole may be residing on a cloud or in a local network such as a local network in an organization. While saving the content to the memory, the user may be able to perform actions such as naming the content, writing description, setting expiry period, setting privacy option and so on. In another embodiment, the enterprise application may have offline functionality. With the offline functionality, the user can create a content even if the user device is not connected to the internet and the enterprise network. In this case, the created content may be stored temporarily in a memory module associated with the user device and may be uploaded to the enterprise network server 105 when internet connectivity is established later.

The expiry option may be used by the user to set time period for which a specific content is to be kept/stored in database associated with the server 105. Using this option, the user may either set time period after which the content may be automatically removed from the database or may set to keep the content forever in the database without deleting.

Further, using the privacy option, the user may be able to set access permissions to each content stored in the database. For example, if the privacy option of content is set to be “public”, anyone may access the content using a link to that particular content. If the privacy option of the content is set to “Private”, only selected email addresses may be able to access that particular content. Similarly, a user may be able to group selected user addresses and provide access to a specific content or a group of contents.

For example, users of a particular enterprise network may be grouped together. Further, those users may be provided access to specific contents or group of contents stored in an enterprise network.

Further, the user may be provided with options to share (805) the created contents. In various embodiments, the user may be able to share the contents via websites such as Facebook, Twitter, Google plus and so on or may be able to email the contents to selected people.

Once the contents have been shared or mailed, then the user may be able to review (808) status of the share contents. While reviewing status, the user may be able to check information such as how many times the content has been viewed by other people, view comments posted by other users and viewers, total number of likes obtained for that particular content in the social networking websites and so on.

Upon logging in, if the user selects the view library option, then the library contents are displayed (806) to the user. In an embodiment, all contents created, uploaded and saved in the memory may be displayed to the user. The user can view status of the contents; whether they have been shared via other websites or not and so on from the library. The library may list videos, audio and whiteboard contents under separate lists and display to the user. The user may also be able to view information such as length of each of the video, audio and whiteboard contents in the library. The user may also have options to sort the library contents according to various attributes such as date of creation of content, length of content, last played and so on. The user may also be able to select certain number of contents i.e. audio, video and/or white board contents and save under a single play list.

In a preferred embodiment, the library contents reside in the enterprise network server 105. Further, the user may be provided with (807) options to manually edit/share selected contents from the library. With the edit option, the user may be able to remove/delete selected contents from the library i.e. from the memory. The user may also be provided with options to sort and display the contents based on various attributes such as date created, date modified, and size of content and so on.

The user may also be able to share selected contents from the library to websites and/or to email to selected people. Further, the user may be able to review (808) status of the shared contents. The multimedia content creation and hosting may be done in any communication system where multiple users create content and host the created contents on a server so as to share with other users. The various actions in method 800 may be performed in the order presented, in a different order or simultaneously. Further, in some embodiments, some actions listed in FIG. 8 may be omitted.

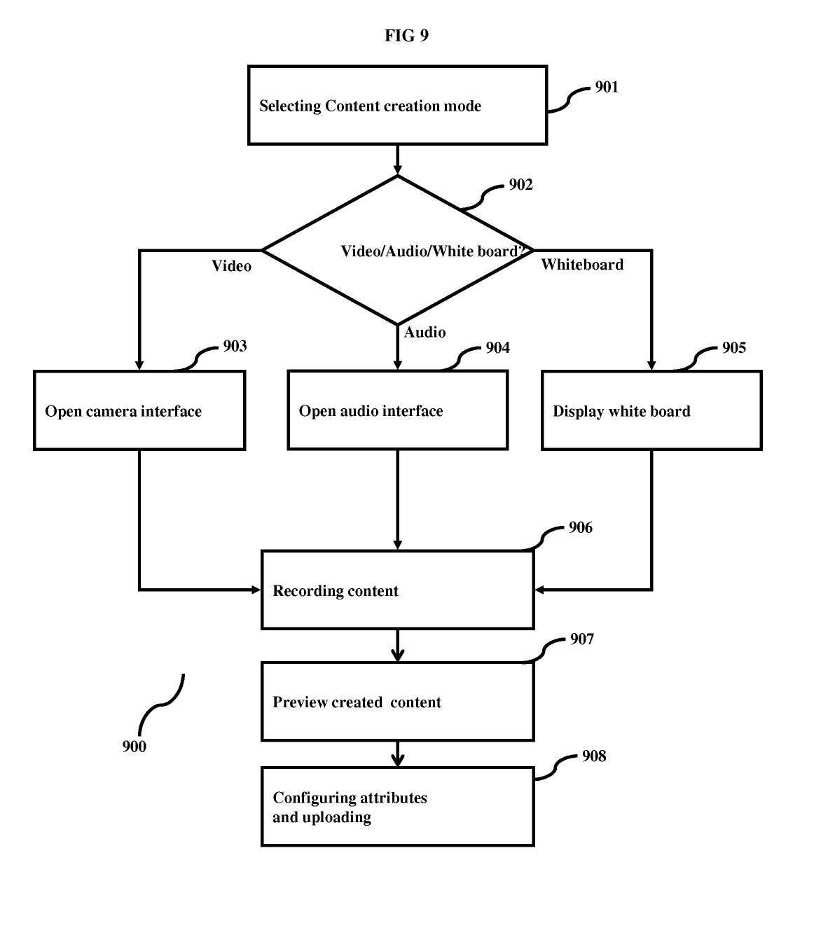

FIG. 9 is a flow diagram that shows various steps involved in the process of creating contents in the enterprise network, as disclosed in the embodiments herein. When a user select create content option after logging in to the enterprise system, he/she is provided with various modes to create the content. The recording modes may comprise audio, video, white board and so on. The user can select (901) at least one of the available options to create the content.

If the user wants to record a video, he/she can select the video recording option, upon which the camera interface is opened (903). The user may be able to configure options such as audio ON/OFF during the video recording, specific time period for which the video is to be captured i.e. length of the video and so on. The user may also be able to select and set a particular camera as the default camera for recording video in a settings screen. Further, with the set configurations and with the selected camera, the user can capture a video.

If the user has selected audio recording option, the mic interface is opened (904). Further the user can configure initial settings for the audio recording purpose. For example, the user can set specific time period for which the audio is to be recorded. The user may also be able to set a particular mic as the default mic for recording audio. Further, with the selected configurations and with the selected mic, the user can record the audio.

If the user selects the white board option, the white board is displayed (905) to the user. Using the white board, the user can manually create drawings, presentations and so on. The user is provided with tools and other options to draw new figures. For example in the white board, the user may be provided with drawing tools like pencil, eraser, color picker, plurality of drawing shapes and so on using which the drawings may be created. Further, the user may also be provided with coloring options to color the created drawing.

Once the content creation option is selected and the corresponding interface is opened, then the user is provided with record option to record (906) the content being created. In an embodiment, the recording option may appear automatically when the selected content creation interface opens. In another embodiment, the user may have to manually select the recording option from a toolbar after selecting the record content mode.

After creating the content, the user can preview (907) the created content using a preview option. In various embodiments, the content may be streamed using a streaming application located in the user device or in the enterprise network server 105. In a preferred embodiment, the enterprise network may host at least one streaming application such as a media player.

Further the created content is uploaded and is stored in the enterprise network server 105. The content may be stored in a library associated with the user account. In a preferred embodiment, the user may be able to set/configure (908) attributes such as name, expiry time, privacy option and so on to the content that is to be stored in the server 105. For example, the user can give a name of his/her choice to the content being created. Further, using the expiry option, the user can decide whether the content is to be expired i.e. auto deleted from the memory after set time period or to be kept in the memory forever. The user may be able to specify the time period after which the content is to be expired. The privacy option may be used to set privacy level of the content to private, public and so on. Setting privacy level may help to restrict access to the content for selected people or a group of people. Further, the data may be uploaded to the server 105. In another embodiment, the user may be provided with option to create meta data for the content created using the selected content creation option. Further, the metadata related to the created content may be uploaded to the server 105.

In a preferred embodiment, the user may also be able to associate the created content with other contents such as data in the form of audio, video, documents or any such suitable format that may be stored in specific folders.

For example, the user may be able to group contents of the same type or contents belonging to same project and store in specific folders. Later, when new content is created which belong to the same category or which is related to the same project, the content may be added to or saved with other contents present in that particular folder.

In an embodiment, tutorial modules may be available in the enterprise network server 105 for the user to access and learn various functionalities of the enterprise network. The user can either stream the videos or may download and watch the videos. The various actions in method 900 may be performed in the order presented, in a different order or simultaneously. Further, in some embodiments, some actions listed in FIG. 9 may be omitted.

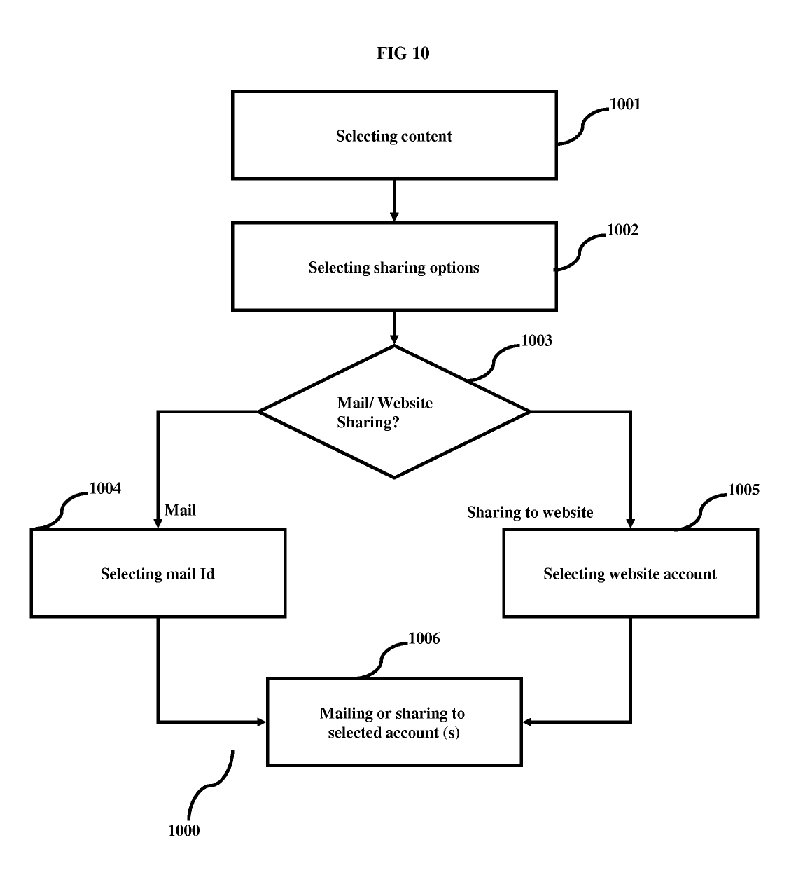

FIG. 10 is a flow diagram that shows various steps involved in the process of sharing created contents through websites in the enterprise network, as disclosed in the embodiments herein. The user can share a content created using the enterprise network application to various video sharing websites, social networking websites and so on. The user can also email a selected content to selected people or a group of people.

The user can select (1001) the content to be shared or emailed from the content library associated with the user account and that resides in the enterprise network server 105. In another embodiment, the user can select share option using any dedicated icon as soon as the content is created.

Once the content is selected, then the user has to select (1002) at least one sharing option. Either the user can select at least one video sharing website or a social networking website to share the content or an emailing option using which the content or a link to the content may be emailed to selected people.

If the user select emailing option, then he/she has to select (1004) at least one email address to which the content is to be mailed. In an embodiment, the user may manually enter the email address in a specific field. Similarly if the user has to share the content to any website, he/she has to select (1005) the web account to which the content is to be shared.

In an embodiment, the email addresses and the website login information are preconfigured with the user's enterprise account manually by the user. Once configured, the login information may be stored in a database associated with the user's enterprise network. Later, the user can select the website using a suitable user interface available. For example, consider that a user has configured his Facebook and Twitter accounts with his enterprise account. Later when he has to share a content to Facebook, he can select the configured account using a suitable interface, preferably by clicking an ON icon against a Facebook icon on the screen. In an embodiment, the user can configure new accounts or delete any of already configured accounts using specific options and user interfaces.

Once the email address and/or the websites are selected, the content is shared (1006) to selected websites or is emailed to selected email addresses. In a preferred embodiment, a link to the specific content may be shared or emailed to selected addresses. Further, the users who click on the link may be redirected to location, preferable a webpage of the content in the enterprise network server 105 where the content is stored. Further, the content may be streamed or downloaded from the specific page.

After sharing a particular content, the user may be able to view status of the shared content. For example, when a content is shared to Facebook and is made visible, viewers may either like the video or may even leave comments. The user can check the library to view the contents and comments and likes received for each of the shared contents. The various actions in method 1000 may be performed in the order presented, in a different order or simultaneously. Further, in some embodiments, some actions listed in FIG. 10 may be omitted.

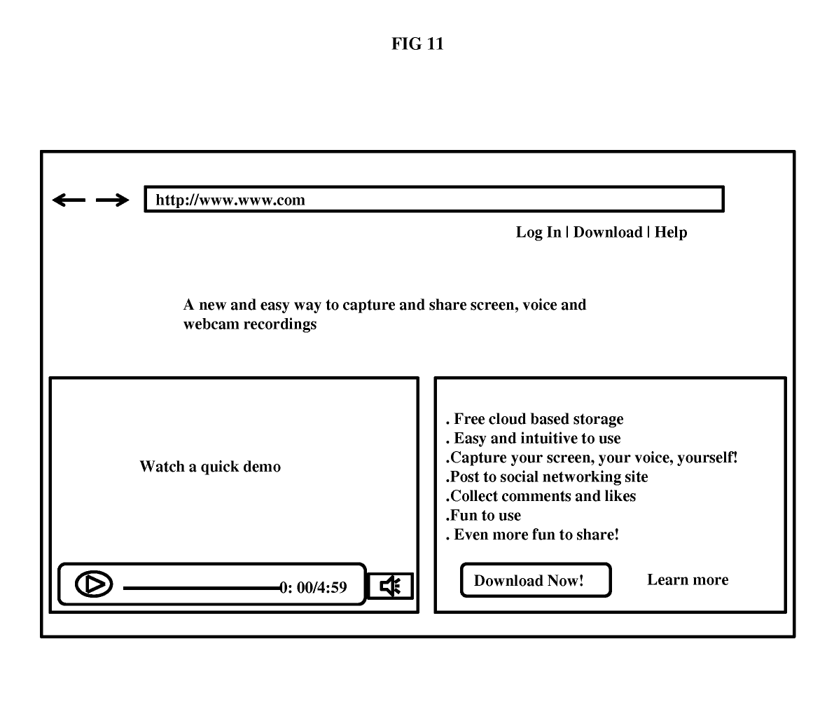

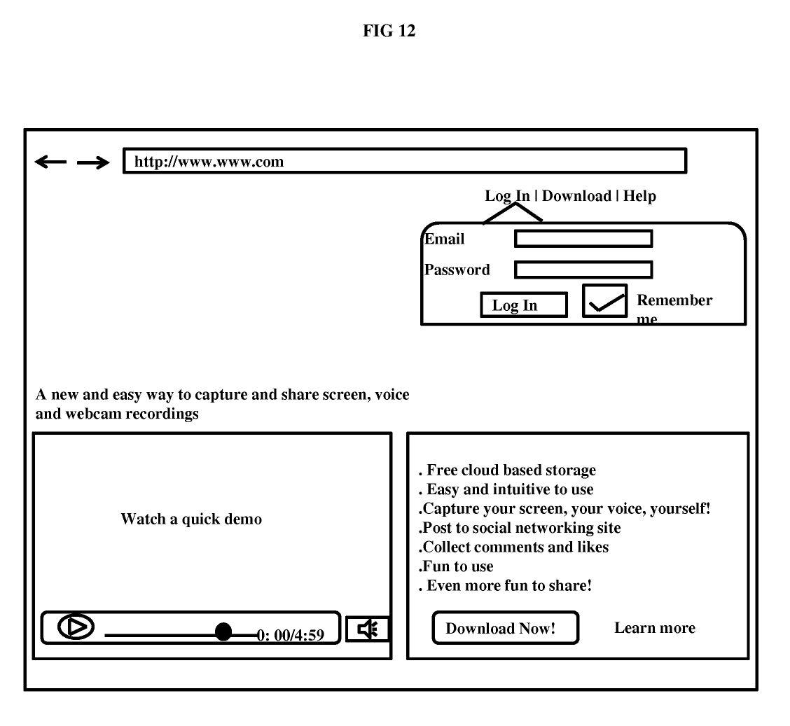

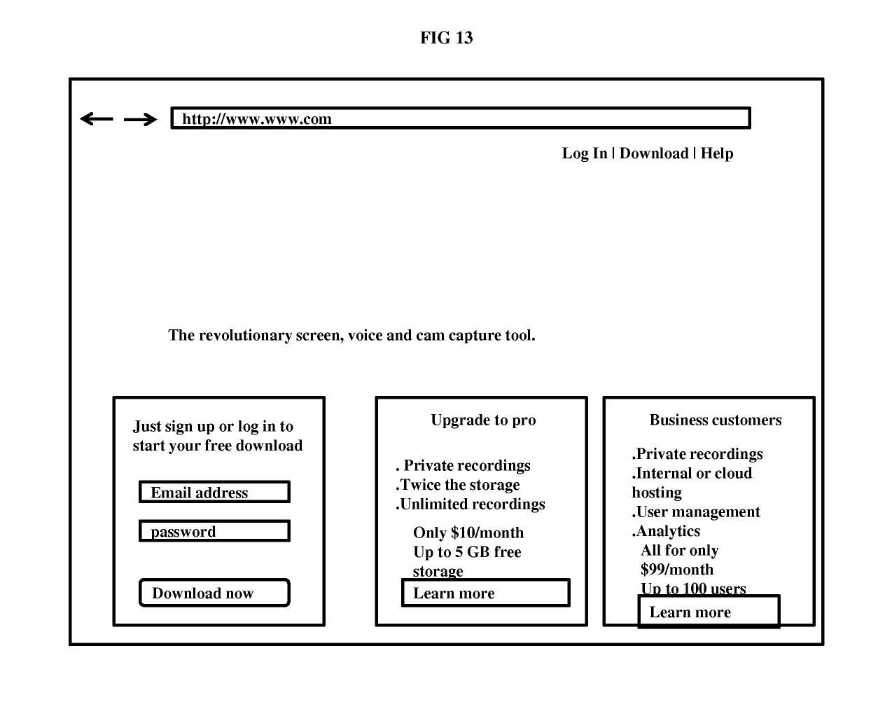

FIGS. 11-23 depict screenshots of various user interfaces provided to the user for creating contents and sharing created contents in the enterprise network, as disclosed in the embodiments herein. The FIG. 11 depicts various options provided to the user as soon as he/she opens the web page associated with the content creation and sharing application. The user can click the “login” option and login to the to the enterprise network by providing login information i.e. registered email Id and password in the login field as depicted in FIG. 12. The user may also be able to login to the enterprise network using login information of any of the suitable websites such as Facebook. The user may also be provided with options such as recover forgotten password, change password, sign up to the network and so on in the login page. In order to change password, the user may have to enter current password and new password in specific fields. Further, using the “download” option the user may be able to download a client application for the enterprise network access and use to the user device. If the user select the “download” option, he/she may be redirected to a page, where specific information such as a login id and a password may be required to be provided to initiate download of the application as in FIG. 13.

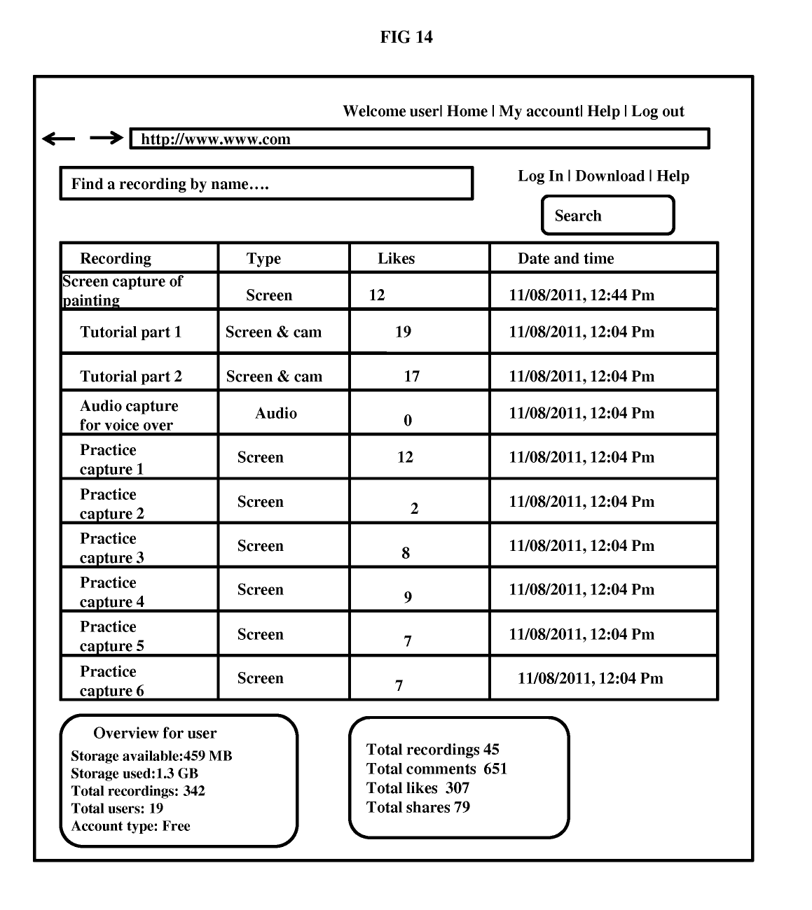

Upon logging in, the user may be redirected to a page where he/she may be provided with a plurality of options such as create content, view library, settings, help and so on to select from. Selecting the “start recording” gives the user options to create and share contents. “My library” options redirects the user to library page as in FIG. 14 where he/she can view contents that have already been created and uploaded to the enterprise network server 105. “Settings” option may be used to view and/or edit various settings associated with the user's enterprise network account. The “Help” option may provide guidance to the user to access and use various functionalities of the enterprise network application and/or to troubleshoot any issues associated with the application. The user may also be able to access tutorial video and/or audio files using the “Help” option. Other options like contact support, user guide and so on may also be available in the Help menu.

The user can select any of audio, video and/or whiteboard modes to create content. When the user select the video recording option, a camera interface associated with the user device is opened using which the user can record the video. Before recording the video, the user can configure settings recording settings using configuration options. Once the video is recorded, the user can preview the recorded video.

The user may record only audio using an audio recording option or else may create a drawing or presentation using a whiteboard option. When the whiteboard option is selected, a whiteboard and associated drawing tools are displayed to the user. The user can create a drawing or a presentation on the white board using suitable user interfaces and available tools. The user may also use coloring option to color the created content in the white board.

Further, the user can use the upload options available so as to upload a created content. Prior to uploading the created content, the user can name the video, add description, set expiry period and set privacy levels using specific options. Further, the user can select the websites to which the video is to be shared and email addresses to which the video is to be emailed. Once the selections are made, then the video is uploaded to the selected websites. If the uploading get failed due to any reason, the user can decide whether to retry or cancel upload.

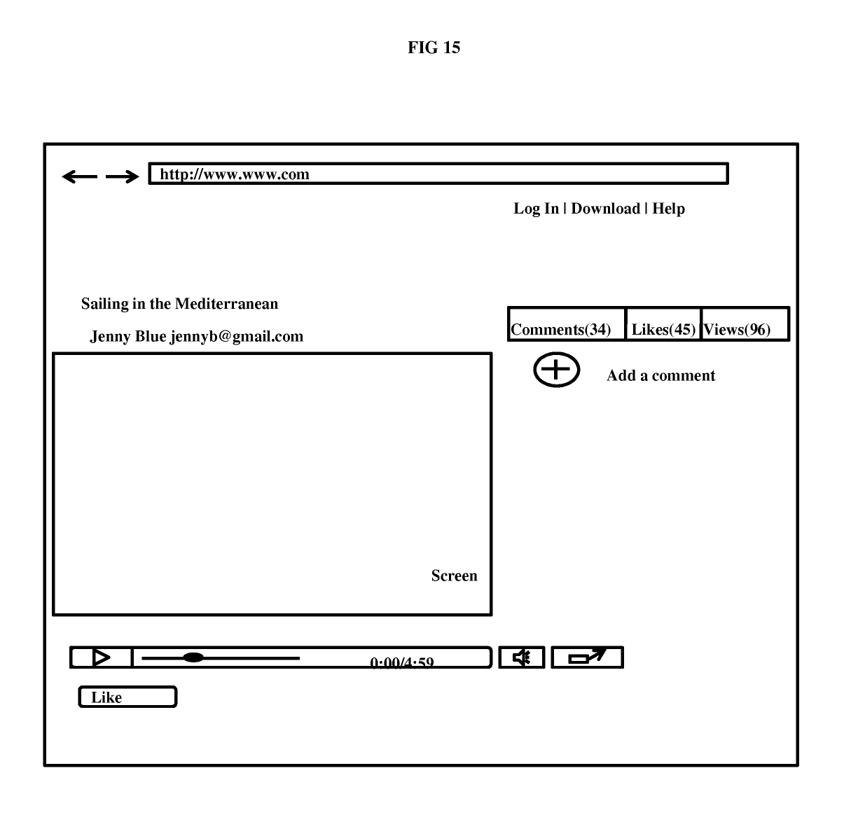

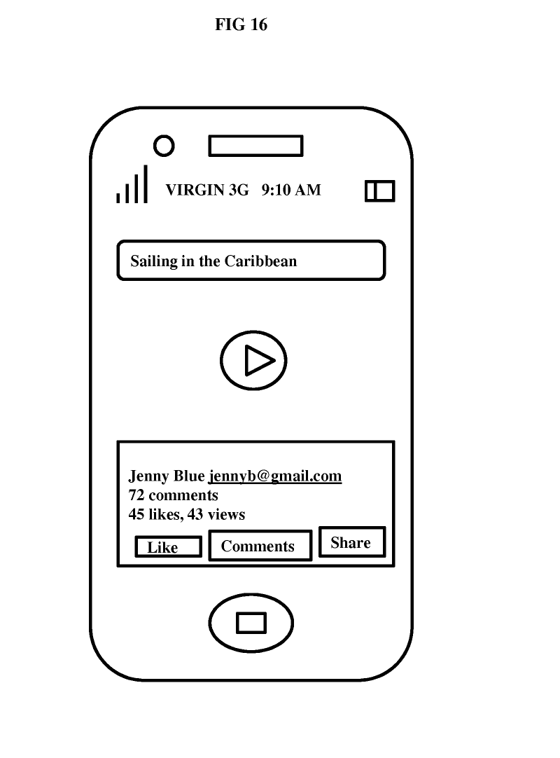

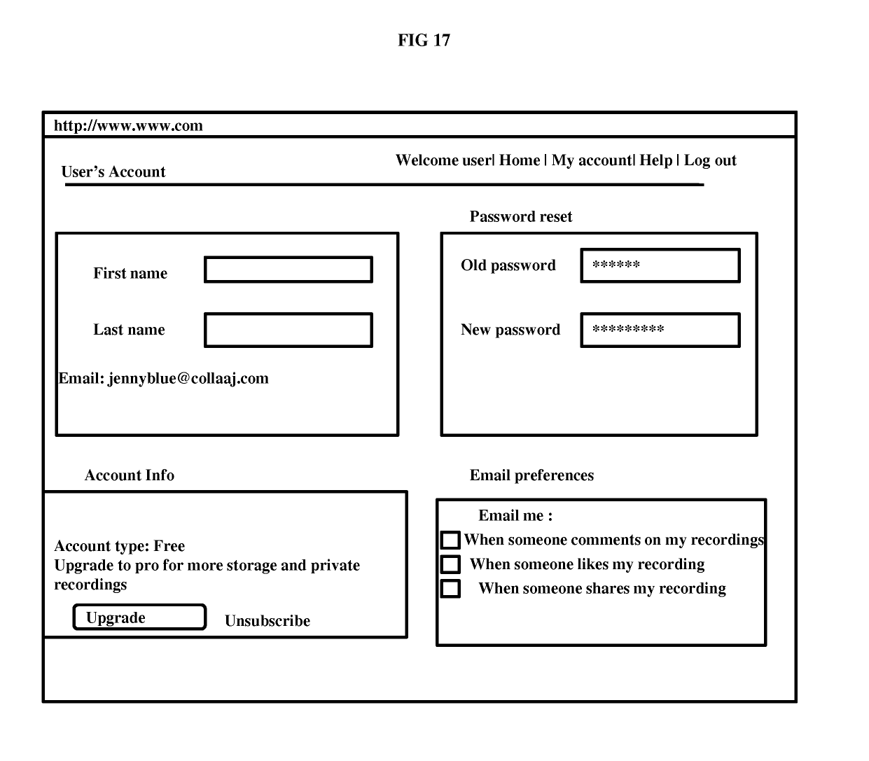

Further, the user can view the contents that have been uploaded to the enterprise network server 105 through the user account in the library as shown in FIGS. 15 and 16. The user may also be able to view information such as length of each content, date of upload and so on in the library. Further, the user may be able to view comments, likes and so on received for each content that has been shared to other websites. Further, the user may also be provided with options to perform actions such as changing/recovering passwords, configuring email alerts, upgrading to premium account and so on as depicted in FIG. 17.

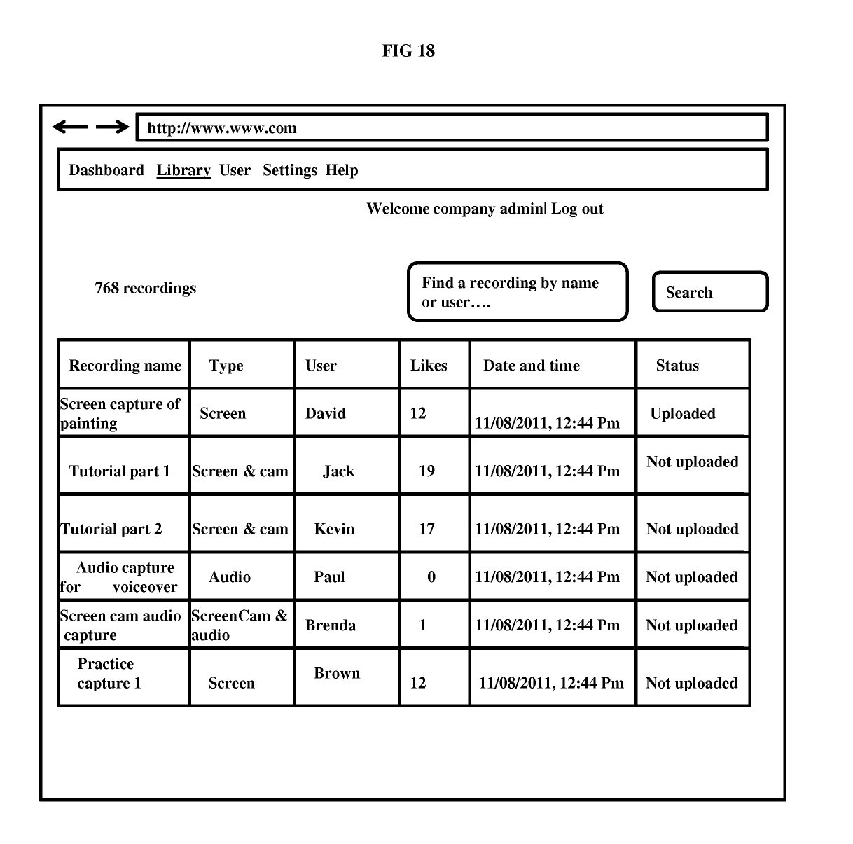

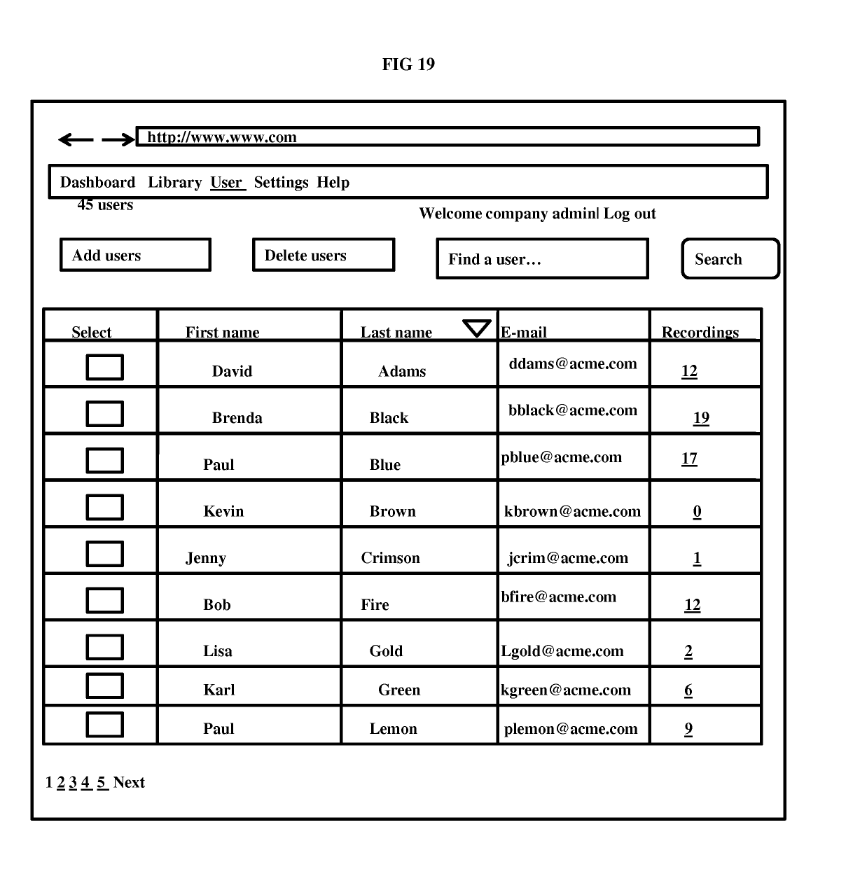

An admin who manages the enterprise network may be able to view library and check and manage various user activity information such as total number of users, content uploaded by each user, whether the uploaded content has been shared or not, date on which each content is uploaded, likes received for each content and so on. The admin may also be able to search and sort contents as depicted in FIG. 18. Further, the admin may also perform actions like search and find a user, add new user, delete already existing user and so on using suitable options as depicted in FIGS. 19, 20, 21 and 22.

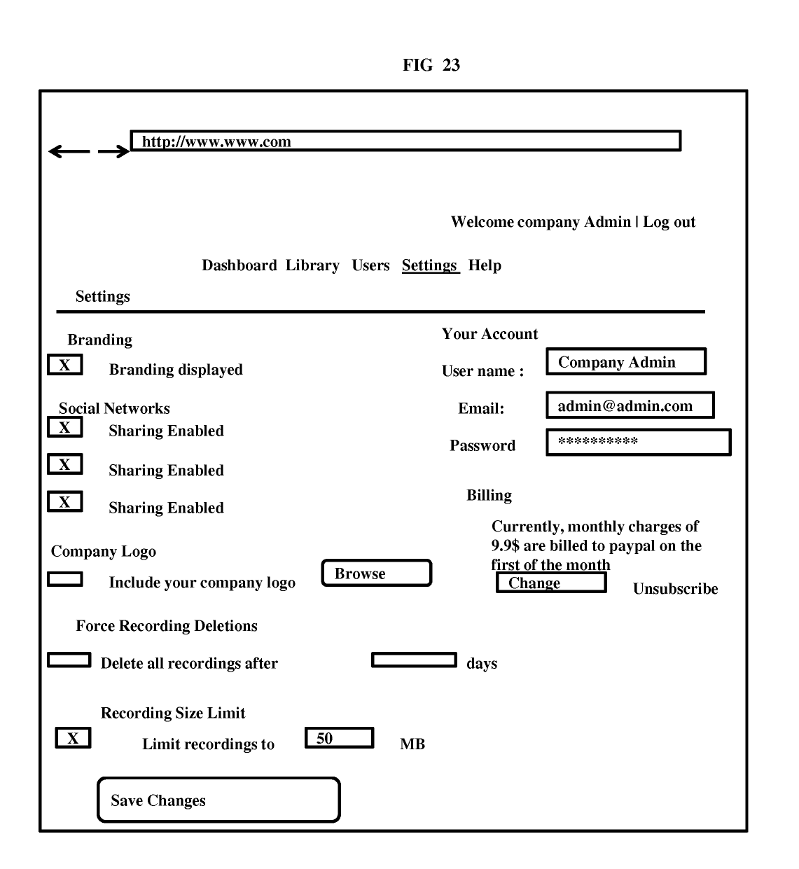

The admin may also configure settings related to branding sharing of contents, billing, maximum length of content that can be recorded, forced deletion of recordings and so on using options as depicted in FIG. 23.

The embodiments disclosed herein can be implemented through at least one software program running on at least one hardware device and performing network management functions to control the network elements. The network elements shown in FIG. 1 and FIG. 2 include blocks which can be at least one of a hardware device, or a combination of hardware device and software module.

The embodiments disclosed herein specify a system for managing multimedia content within enterprises. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in a preferred embodiment through or together with a software program written in e.g. Very high speed integrated circuit Hardware Description Language (VHDL) another programming language, or implemented by one or more VHDL or several software modules being executed on at least one hardware device. The hardware device can be any kind of device which can be programmed including e.g. any kind of computer like a server or a personal computer, or the like, or any combination thereof, e.g. one processor and two FPGAs. The device may also include means which could be e.g. hardware means like e.g. an ASIC, or a combination of hardware and software means, e.g. an ASIC and an FPGA, or at least one microprocessor and at least one memory with software modules located therein. Thus, the means are at least one hardware means and/or at least one software means. The method embodiments described herein could be implemented in pure hardware or partly in hardware and partly in software. The device may also include only software means (where the software means may be delivered in the form of a software application that can be installed on a general purpose Windows/*nix server/desktop Operating System). Alternatively, the invention may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

I claim:

1) A method for managing content in an enterprise network, said method comprises:
presenting one or more options to choose a content creation mode;
creating said content based on selected option to create content from among said options to create content, wherein said content is one or a combination of one or more among audio, camera video, whiteboard video, screen share video, application share video and screen capture image;
creating metadata for said created content;
transferring said content to a server for hosting;
presenting options to share said hosted content; and
sharing said content based on selected option to share from among said options to share.

2) The method as in claim 1, wherein said presenting option to share said hosted content further comprises displaying at least one of an email sharing and a web sharing options.

3) The method as in claim 1, wherein said created content is grouped into buckets before transferring to said server for hosting.

4) The method as in claim 1, wherein said created content is associated with at least one of other content.

5) The method as in claim 1, wherein said hosting of the content on said server further comprises:
fetching said content from a user;
authenticating said user and user action; and
storing said fetched content, when said authentication is successful.

6) The method as in claim 5, wherein said storing the fetched content may further comprise configuring plurality of attributes to said content.

7) The method as in claim 6, wherein said attribute may be at least one of a name, an expiry time, privacy level corresponding to said content.

8) The method as in claim 1, wherein said options to share include:
option to email a link to the content hosted on said server;
option to share said link to a social media sharing website; and
option to share said link through an instant message to one or more users.

9) The method as in claim 8, wherein said sharing is done with privacy level set to public option.

10) The method as in claim 8, wherein said sharing is performed with privacy level set to private option.

11) The method as in claim 8, wherein said sharing is performed with access to said shared content limited for at least one of a selected user or a selected group of users.

12) The method as in claim 8, wherein said sharing links using at least one of said email or instant message further comprises:
selecting at least one of a plurality of email addresses or instant messaging Ids from a database; and
sharing said link to said selected email addresses or instant messaging Ids.

13) A method of providing access to content stored in an enterprise network, said method comprises:
receiving a content access request from a user;
authenticating said user and user action;
fetching said requested content on said authentication being successful; and
streaming said fetched content to said user based on said request.

14) The method as in claim 14, wherein said authenticating the user may further comprise comparing at least one of a plurality of user attributes with data present in a database associated with a server in said enterprise network.

15) A system for managing content in an enterprise network, said system provided with at least one means configured for:
presenting one or more options to choose a content creation mode using a user device;
creating said content based on selected option to create content from among said options to create content, wherein said content is one or a combination of one or more among audio, camera video, whiteboard video, screen share video, application share video and screen capture image using a unified multimedia appliance;
creating metadata for said created content using said unified multimedia appliance;
transferring said content to a server for hosting using said unified multimedia appliance;
presenting options to share said hosted content using said user device; and
sharing said content based on selected option to share from among said options to share using said unified multimedia appliance.

16) The system as in claim 15 is further configured for grouping said created content into buckets before transferring to said server for hosting.

17) The system as in claim 15 is further configured for associating said created content with at least one of other content.

18) The system as in claim 15 is further configured for hosting said content on said server by:
fetching said content from a user using said unified multimedia appliance;
authenticating said user and user action using said unified multimedia appliance; and
storing said fetched content, when said authentication is successful on said server using said unified multimedia appliance.

19) The system as in claim 18 is further configured for configuring a plurality of attributes to said content while storing said fetched content.

20) The system as in claim 15 is further configured for sharing said content using at least one of an email or social media sharing website or an instant message sharing options.

21) The system as in claim 20 is further configured for sharing said content with privacy level set to public option.

22) The system as in claim 20 is further configured for sharing said content with privacy level set to private option.

23) The system as in claim 20 is further configured for sharing said content with access to said shared content limited for at least one of a selected user or a selected group of users.

24) The system as in claim 20 is further configured for sharing links using at least one of said email or instant message by:
selecting at least one of a plurality of email addresses or instant messaging Ids from a database using said user device; and
sharing said link to said selected email addresses or instant messaging Ids using said unified multimedia appliance.

25) A system of providing access to content stored in an enterprise network, said system provided with at least one means configured for:
receiving a content access request from a user using a user device;
authenticating said user and user action using a unified multimedia appliance;
fetching said requested content on said authentication being successful using said unified multimedia appliance; and
streaming said fetched content to said user based on said request using said unified multimedia appliance.

26) The system as in claim 25 is further configured for authenticating the user by comparing at least one of a plurality of user attributes with data present in a database associated with a server in said enterprise network.
